(19) United States
(12) Patent Application Publication
(10) Pub. No.: US 2009/0153418 A1
(43) Pub. Date: Jun. 18, 2009

(54) Device for receiving radio waves

(75) Inventor: Sung Jun Park, Seodaemun-gu (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/284,186

(22) Filed: Sep. 19, 2008

(30) Foreign Application Priority Data
Dec. 17, 2007 (KR) 10-2007-0132840

(51) Int. Cl. H01Q 1/32; H01Q 1/24

(52) U.S. Cl. 343/702; 343/711

(57) ABSTRACT

Disclosed herein is a device for receiving radio waves. The device includes an antenna module, an operation control unit, and signal processing units. The antenna module includes an antenna pole, which is provided in an antenna base so as to be extensible and contractible in order to receive various types of radio waves, and a pole drive unit, which is coupled to the lower end of the antenna pole to increase or decrease the length of the antenna pole. The operation control unit detects the length of the antenna pole and controls the length of the antenna pole by providing a desired drive force to the pole drive unit. Each of the signal processing units includes a buffer and filter, which are used to process radio waves received from the antenna module.

### CROSS-REFERENCE TO RELATED APPLICATION

This application claims under 35 U.S.C. §119(a) the benefit of Korean Patent Application No. 10-2007-0132840 filed Dec. 17, 2007, the entire contents of which are incorporated herein by reference.

### BACKGROUND OF THE INVENTION

1. Field of the Invention

The present invention relates generally to a device for receiving radio waves, which is mounted to a vehicle or other piece of equipment, so that both radio broadcasting signals and Digital Multimedia Broadcasting (DMB) signals can be received using a single antenna.

2. Description of the Related Art

Recently, various types of antennas, which are used for communication devices, such as a Global Positioning System (GPS), a Code Division Multiple Access communication device, and a DMB device, as well as a radio system, have come to be widely used. Particularly, in a vehicle, an antenna unit in which the four types of antennas are mounted has been introduced, and thus it is possible to receive radio broadcasting signals, to use a navigator, to use a mobile phone, and to receive TV broadcast signals in a vehicle. In a conventional device for receiving radio waves, all of the antenna poles used for the four types of devices are provided in a single antenna base, and are connected to a head unit by corresponding cables.

The conventional device for receiving radio waves is described with reference to exemplary FIGS. 1A and 1B. FIG. 1A is a diagram showing the construction of an exemplary conventional device for receiving radio waves. As shown in FIG. 1A, a radio antenna pole 12, a DMB antenna pole 16, a GPS antenna pole 19 and a CDMA antenna pole 18 are provided in an antenna base 11. In particular, the radio antenna pole 12 is coupled to a drive unit 14 so as to be expansible. A spring type DMB antenna pole is used for the DMB antenna pole 16. The antenna poles and the drive unit 14 constitute an antenna module 10. The antenna module 10 is connected to a head unit 50 using cables 30.

FIG. 1B is a conceptual diagram showing the antenna module and the head unit. The antenna poles are connected to respective buffers in the antenna module 10. The buffers are connected to respective receivers, which are provided in the head unit 50, via the respective cables 30.

However, in the conventional device for receiving radio waves, a plurality of antenna poles must be provided in the device, a plurality of cables is used to connect the antenna poles and the head unit to each other, and each of the cables has a length of 5˜6 m, so that the cost is increased in proportion to the increase in the number of parts.

Furthermore, in the DMB antenna pole, which is a spring type antenna, the receiver sensitivity that is attained is lower than that attained when a radio antenna pole is used, which can be problematic.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the present invention is directed to a device for receiving radio waves, in which a radio antenna pole and a DMB antenna pole are suitably integrated into a single antenna pole, and the antenna pole is configured to be extensible and contractible in the longitudinal direction thereof, thus simplifying the construction of the device by decreasing the number of antenna poles and cables, reducing the cost, and suitably improving the receiver sensitivity.

In one embodiment, the present invention provides a device for receiving radio waves, preferably including, but not limited to, an antenna module comprising an antenna pole, which is provided in an antenna base so as to be extensible and contractible in order to receive various types of radio waves, and a pole drive unit, which is suitably coupled to the lower end of the antenna pole to increase or decrease the length of the antenna pole; an operation control unit for detecting the length of the antenna pole and controlling the length of the antenna pole by providing a desired drive force to the pole drive unit; and signal processing units each comprising a buffer and filter, which are used to process radio waves received from the antenna module.

In certain embodiments, tt is preferred that the signal processing units be provided in a head unit, the head unit being suitably connected with the antenna module using a single cable.

In other embodiments, tt is preferred that the pole drive unit include a reversible motor and a gear assembly, and that the operation control unit generate a reference voltage using both a separate power source and a rotary variable resistor, the resistance value of which varies according to the rotation of the reversible motor, measure the reference voltage using a rotation type variable volume sensor, and provide a suitable drive force, corresponding to the measured reference voltage, to the reversible motor.

In other embodiments, tt is preferred that the operation control unit enter an OFF mode when the reference voltage falls within a range of 0˜0.5 volts, a DMB mode when the reference voltage falls within a range of 2.25˜2.75 volts, and an FM/AM radio mode when the reference voltage falls within a range of 4.5˜5 volts, and that the reversible motor be operated according to the modes.

In further embodiments, tt is preferred that the antenna pole be a rod type antenna pole, which includes a helical spring, which is suitably expanded and contracted according to the operation of the pole drive unit, a collapsible waveguide, and a fastening part, which is configured such that one end of the spring is fastened to one end of the waveguide.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are diagrams showing an example of a conventional device for receiving radio waves, in which FIG. 1A is a diagram showing the structure of the conventional device for receiving radio waves, and FIG. 1B is a diagram showing the construction of the conventional device for receiving radio waves.

FIGS. 2A and 2B are diagrams showing a device for receiving radio waves according to an embodiment of the present invention, in which FIG. 2A is a diagram showing the structure of the device for receiving radio waves according to an embodiment of the present invention, and FIG. 2B is a diagram showing the construction of the device for receiving radio waves according to an embodiment of the present invention.

FIG. 3 is a diagram showing the operation control unit and the head unit of the device for receiving radio waves, shown in FIG. 2A.

FIG. 4 is a flowchart illustrating the operation control unit of the device for receiving radio waves, shown in FIG. 2A.

FIGS. 5A, 5B and 5C are views showing a pole of the device for receiving radio waves, shown in FIG. 2A, in which FIG. 5A is a view showing the state in which the pole is collapsed, FIG. 5B is a view showing the state in which the pole is extended, and FIG. 5C is a sectional view taken along line A-A of portion S in FIG. 5B.

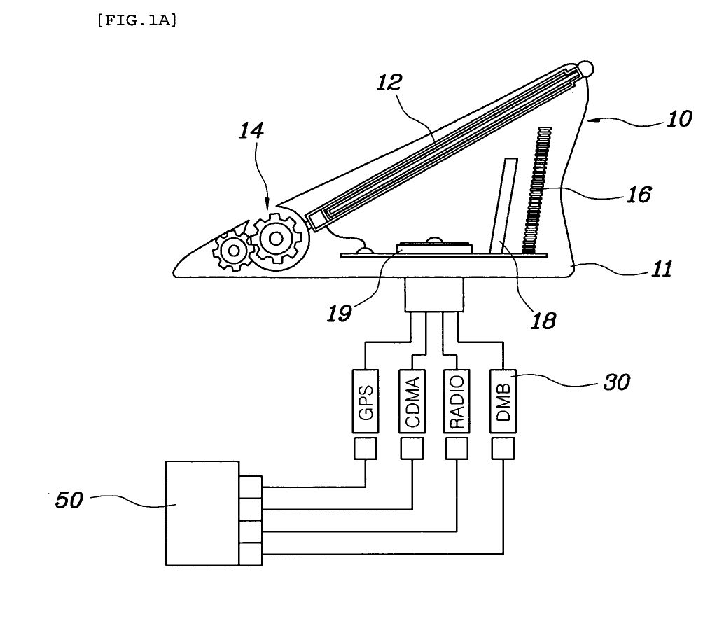

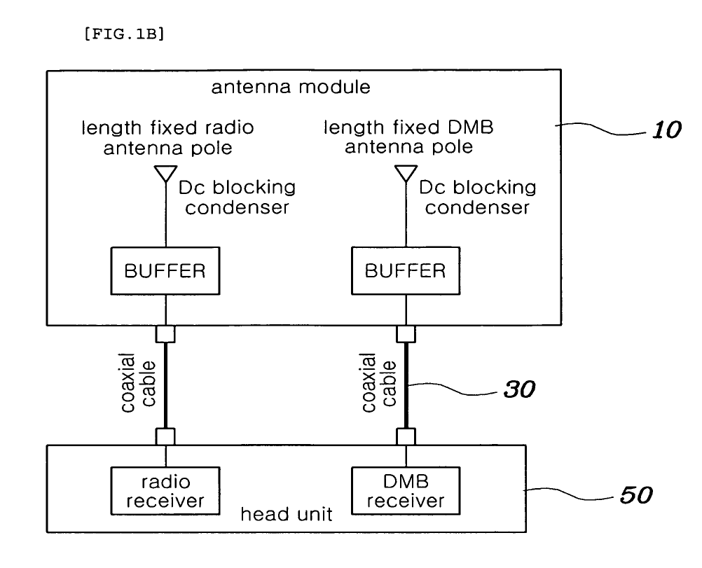

### DESCRIPTION OF THE PREFERRED EMBODIMENTS

As described herein, the present invention includes a device for receiving radio waves, comprising an antenna module comprising an antenna pole, which is provided in an antenna base so as to be extensible and contractible in order to receive various types of radio waves, and a pole drive unit, an operation control unit for detecting the length of the antenna pole and controlling the length of the antenna pole by providing a desired drive force to the pole drive unit, and signal processing units.

In one embodiment, the pole drive unit is coupled to a lower end of the antenna pole to increase or decrease a length of the antenna pole. In another embodiment, the signal processing units each comprise a buffer and a filter, which are used to process radio waves received from the antenna module. In a further embodiment, the signal processing units are provided in a head unit. In preferred embodiments, the head unit is connected with the antenna module using a cable. In related embodiments, the cable is a single cable.

The invention can also include a motor vehicle comprising a device for receiving radio waves as described herein.

A device for receiving radio waves according to certain preferred embodiments of the present invention is described in detail with reference to the accompanying drawings below.

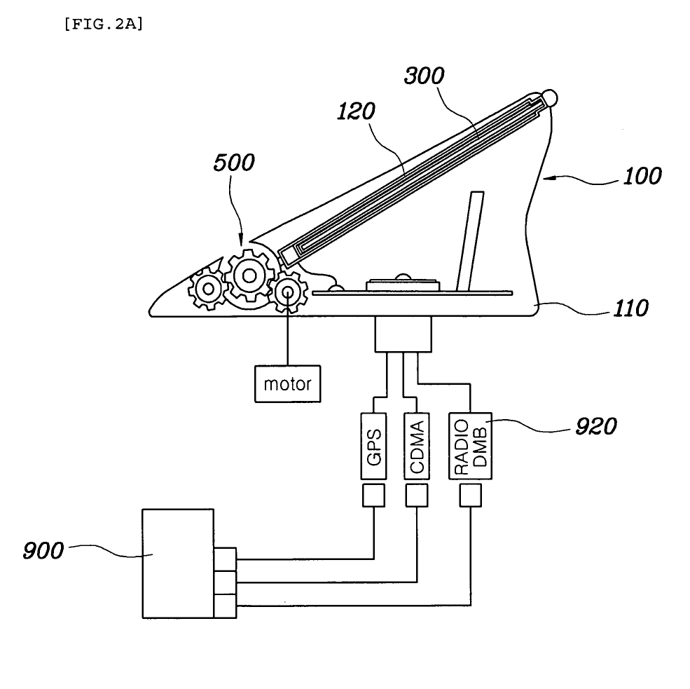

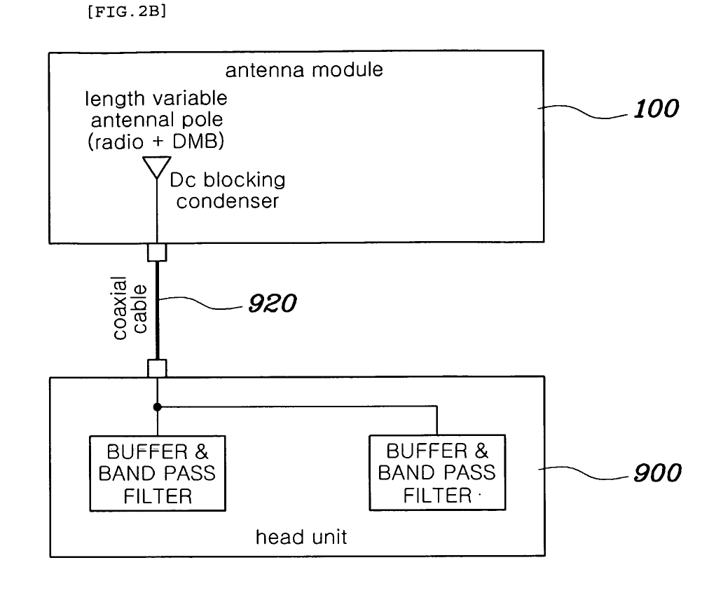

The overall construction of the device for receiving radio waves is described with reference to exemplary FIGS. 2A and 2B. Exemplary FIG. 2A is a diagram showing an exemplary structure of the device for receiving radio waves according to a preferred embodiment of the present invention. In exemplary embodiments, the device for receiving radio waves preferably includes an antenna module 100 including an antenna pole 300, which is suitably provided in an antenna base 110 so as to be extensible and contractible in order to receive various types of radio waves, and a pole drive unit 500, which is suitably coupled to the lower end of the antenna pole to increase or decrease the length of the antenna pole 300, an operation control unit 700, for detecting the length of the antenna pole 300 and controlling the length of the antenna pole 300 by providing a desired drive force to the pole drive unit 500, and signal processing units, wherein each signal processing unit preferably includes a buffer and a filter, which are used to process radio waves received from the antenna module 100.

In certain embodiments, it is preferred that the operation control unit 700 control the length of the antenna pole 300 by measuring a reference voltage, corresponding to the length of the antenna pole 300 using a variable resistor, the resistance value of which varies according to the length of the antenna pole 300, and providing a drive force, corresponding to the measured reference voltage, to the pole drive unit 500. The signal processing unit may be provided in the antenna module 100 or a separate head unit 900. In order to process radio broadcasting signals and DMB signals, in certain embodiments it is preferable to use two signal processing units. Accordingly, in exemplary embodiments, when the signal processing unit is provided in the head unit 900, the antenna unit 100 can be connected with the head unit 900 using a single cable 920, and thus the cost can be reduced.

FIG. 2B is a diagram showing the construction of the device for receiving radio waves according to an exemplary embodiment of the present invention. The antenna module 100 may include an integrated antenna pole and a condenser. The head unit 900 may include the signal processing units, each of which may include a buffer and a filter, and radio and DMB receivers, which correspond to the respective signal processing units. In preferred embodiments, the antenna module 100 and the head unit 900 are connected to each other using a single cable 920. For example, the number of cables is decreased from two to one, and the buffers and the filters are preferably mounted in the head unit 900.

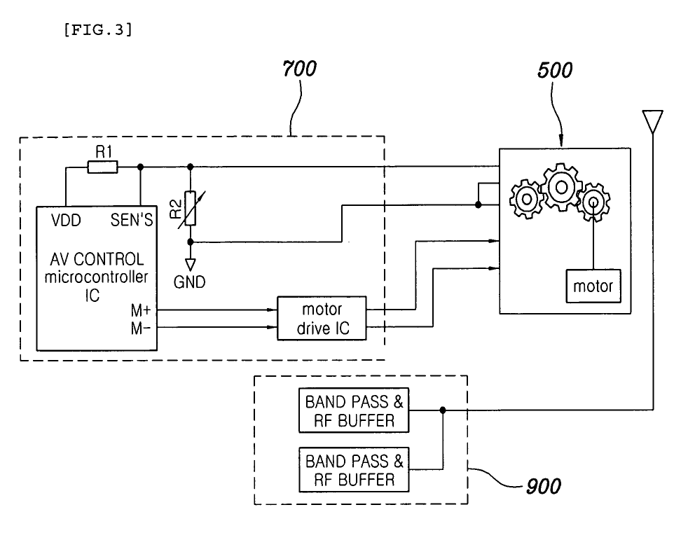

FIG. 3 is a diagram showing an exemplary operation control unit and head unit of the device for receiving radio waves. The pole drive unit 500 preferably includes a reversible motor and a gear assembly. The operation control unit 700 preferably includes a rotation type variable volume sensor for measuring a reference voltage, which is generated using both a rotary variable resistor, the resistance value of which varies according to the rotation of the reversible motor, and a separate power source, and a microcontroller for providing the reversible motor to a drive force, which corresponds to the measured reference voltage.

Furthermore, it is preferred in certain cases that the microcontroller enters the OFF mode when the reference voltage falls within a range of 0˜0.5 volts, a DMB mode when the reference voltage falls within a range of 2.25˜2.75 volts, and an FM/AM radio mode when the reference voltage falls within a range of 4.5˜5 volts, and that the reversible motor be operated according to the modes.

A description of the concept of operation in both the radio mode and the DMB mode is given below. An AV microcontroller, which has detected an operation mode, operates the motor by controlling a motor control Integrated Circuit (IC). In certain examples, the resistance value of the rotation type volume sensor varies. Accordingly, this causes variation in the reference voltage. In a resistance division scheme, the amount of variation in voltage is described below. Here, the value of R2 is varied according to the rotation of the motor (the moved distance of a pole).

Reference voltage=R2/R1+R2*VDD

Preferably, when each reference voltage is input to the input terminals of the sensor, the output of terminals M+ and M− is controlled, and thus the rotation of the motor is controlled. Reference voltages for respective modes are as following:

In radio mode: reference voltage=4.5˜5.0 V [a pole length of 1.35 m]

In DMB mode: reference voltage=2.25˜2.75 V [a pole length of 0.675 m]

In AV OFF mode or other mode: reference voltage=0˜0.5 V [no exposure of pole]

Although the length of the antenna pole can be precisely adjusted according to the actual reception frequencies in the modes, it is preferred that the length of the antenna pole be merely adjusted according to the modes in consideration of the durability of the motor.

For reference, in exemplary embodiments as described herein, the length of the antenna pole is calculated based on the velocity of radio waves/reception frequency*wavelength*wavelength shortening rate. Thus, the length of the radio antenna pole is 300 km/100 MHz*1/2*0.9=1.35 m (when a half wavelength antenna is used), and the length of the DMB antenna pole is 300 km/200 MHz*1/2*0.9=0.675 m (when a half wavelength antenna is used).

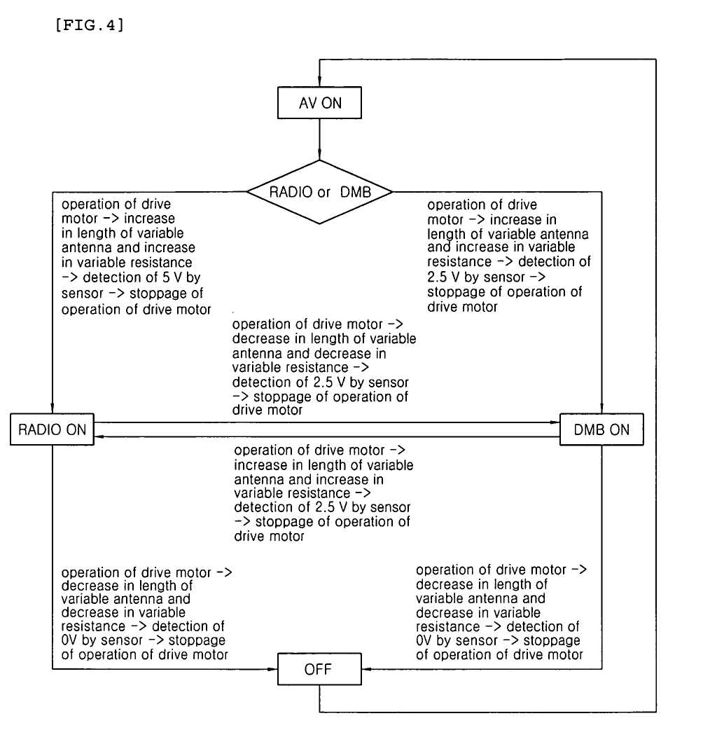

A description of variation in the length of the pole 300 according to the modes is given below with reference to exemplary FIG. 4. When an AV system is turned on and then the microcontroller enters the radio mode in an initial state, the pole 300 is protruded while sawteeth engaging gears are rotated by the reversible motor, and thus the rotary variable resistor is turned. Accordingly, the length of the pole 300 is increased, so that the variable resistance is suitably increased, therefore the voltage measured by the sensor is increased. In this case, when the voltage falls within a voltage range of 4.5˜5 volts, the microcontroller stops the operation of the reversible motor. When the operation of the reversible motor is stopped, the length of the pole 300 is 1.35 m. The time taken for the voltage to change from 0 volts to 5 volts is the same as the operation time of the reversible motor.

In preferred embodiments, when the microcontroller enters the DMB mode in an initial state, the pole 300 is protruded while the sawteeth engaging gears are rotated by the reversible motor, and thus the rotary variable resistor is turned. Accordingly, the length of the pole 300 is increased, so that the variable resistance is increased, therefore the voltage measured by the sensor is increased. In preferred embodiments, when the voltage falls within a voltage range of 2.25˜2.75 volts, the microcontroller stops the operation of the reversible motor. When the operation of the reversible motor is stopped, the length of the pole 300 is 0.65 m. The time taken for the voltage to change from 0 volts to 2.5 volts is the same as the operation time of the reversible motor.

In certain embodiments, when the mode is changed from the radio mode to the DMB mode, the pole 300 is retracted while the sawteeth engaging gears are rotated by the reversible motor, and thus the rotary variable resistor is turned. Accordingly, the length of the pole 300 is decreased, so that the variable resistance is decreased, therefore the voltage measured by the sensor is decreased. In certain exemplary embodiments, when the voltage falls within a voltage range of 2.25˜2.75 volts, the microcontroller stops the operation of the reversible motor. When the operation of the reversible motor is stopped, the length of the pole 300 is 0.65 m. The time taken for the voltage to change from 5 volts to 2.5 volts is the same as the operation time of the reversible motor.

In further embodiments, when the mode is changed from the DMB mode to the radio mode, the pole 300 is protruded while the sawteeth engaging gears are rotated by the reversible motor, and thus the rotary variable resistor is suitably turned. Accordingly, the length of the pole 300 is increased, so that the variable resistance is increased, therefore the voltage measured by the sensor is increased. Accordingly, when the voltage is 5 volts, the microcontroller stops the operation of the reversible motor. When the operation of the reversible motor is stopped, the length of the pole 300 is 1.35 m. The time taken for the voltage to change from 2.5 volts to 5 volts is the same as the operation time of the reversible motor.

In certain embodiments, when the DMB mode or the radio mode is turned off, the pole 300 is retracted while the sawteeth engaging gears are rotated by the reversible motor, and thus the rotary variable resistor is turned. Accordingly, the length of the pole 300 is decreased, so that the variable resistance is decreased, and thus the voltage measured by the sensor is decreased. In exemplary embodiments, when the voltage is 0 volts, the microcontroller stops the operation of the reversible motor. Accordingly, when the operation of the reversible motor is stopped, the pole 300 is placed in the initial state. The time taken when the voltage varies is the same as the operation time of the reversible motor.

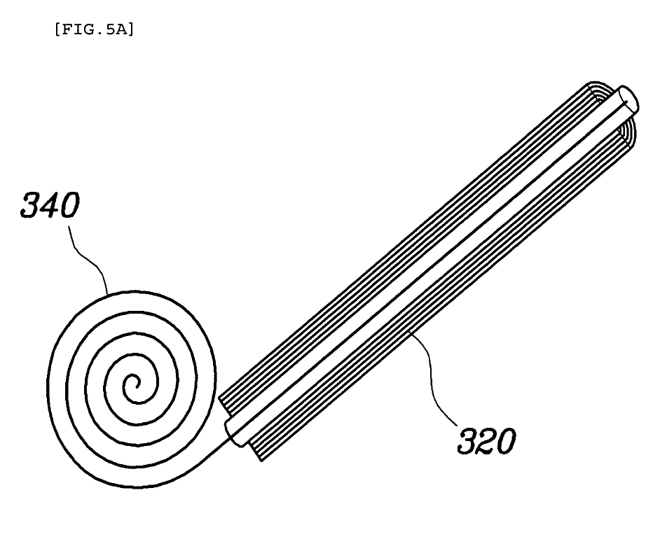

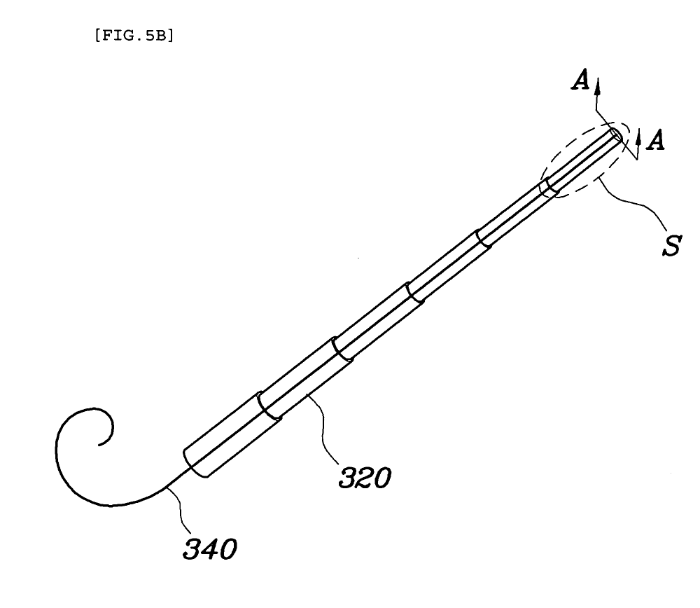

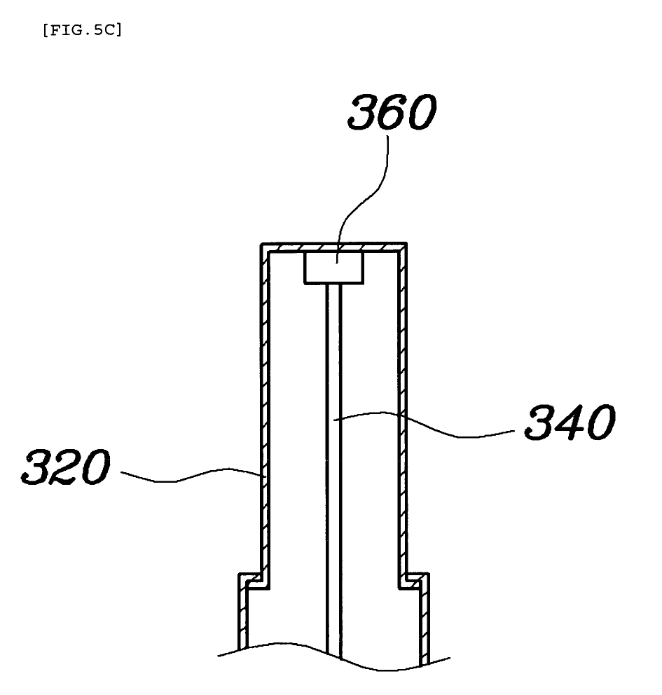

A description of the antenna pole is given below with reference to FIGS. 5A, 5B and 5C. In certain embodiments, it is preferred that the antenna pole 300 of the antenna module be a rod type antenna pole, which preferably includes a helical spring 340, which is expanded and contracted according to the rotation of the pole drive unit 500, a collapsible waveguide 320, and a fastening part 360, which is provided in one end of the waveguide 320 and is preferably configured to fasten one end of the spring 340. Accordingly, a rectilinear length longer than that of the conventional DMB antenna pole 16 is ensured, and the reception rate is increased.

As described above, in the device for receiving radio waves, in preferred embodiments, the radio antenna pole and the DMB antenna pole are suitably integrated into a single antenna pole, and reception can be performed in various ways according to the expansion and contraction of the antenna pole for the respective modes, so that the construction of the device can be simplified, the cost can be reduced, the number of cables can be suitably decreased, and the DMB reception performance can be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for receiving radio waves, comprising:
an antenna module comprising an antenna pole, which is provided in an antenna base so as to be extensible and contractible in order to receive various types of radio waves, and a pole drive unit, which is coupled to a lower end of the antenna pole to increase or decrease a length of the antenna pole;
an operation control unit for detecting the length of the antenna pole and controlling the length of the antenna pole by providing a desired drive force to the pole drive unit; and
signal processing units each comprising a buffer and filter, which are used to process radio waves received from the antenna module.

2. The device for receiving radio waves as set forth in claim 1, wherein the signal processing units are provided in a head unit, the head unit being connected with the antenna module using a single cable.

3. The device for receiving radio waves as set forth in claim 1, wherein:
the pole drive unit comprises a reversible motor and a gear assembly; and
the operation control unit generates a reference voltage using both a separate power source and a rotary variable resistor, a resistance value of which varies according to rotation of the reversible motor, measures the reference voltage using a rotation type variable volume sensor, and provides a drive force, corresponding to the measured reference voltage, to the reversible motor.

4. The device for receiving radio waves as set forth in claim 3, wherein the operation control unit enters an OFF mode when the reference voltage falls within a range of 0˜0.5 volts, a Digital Multimedia Broadcasting (DMB) mode when the reference voltage falls within a range of 2.25˜2.75 volts, and an FM/AM radio mode when the reference voltage falls within a range of 4.5˜5 volts, and operates the reversible motor according to the modes.

5. The device for receiving radio waves as set forth in claims 1, wherein the antenna pole is a rod type antenna pole, which comprises a helical spring, which is expanded and contracted according to operation of the pole drive unit, a collapsible waveguide, and a fastening part, which is configured such that one end of the spring is fastened to one end of the waveguide.

6. The device for receiving radio waves as set forth in claims 2, wherein the antenna pole is a rod type antenna pole, which comprises a helical spring, which is expanded and contracted according to operation of the pole drive unit, a collapsible waveguide, and a fastening part, which is configured such that one end of the spring is fastened to one end of the waveguide.

7. The device for receiving radio waves as set forth in claims 3, wherein the antenna pole is a rod type antenna pole, which comprises a helical spring, which is expanded and contracted according to operation of the pole drive unit, a collapsible waveguide, and a fastening part, which is configured such that one end of the spring is fastened to one end of the waveguide.

8. A device for receiving radio waves, comprising:
an antenna module comprising an antenna pole, which is provided in an antenna base so as to be extensible and contractible in order to receive various types of radio waves, and a pole drive unit;
an operation control unit for detecting the length of the antenna pole and controlling the length of the antenna pole by providing a desired drive force to the pole drive unit; and
signal processing units.

9. The device for receiving radio waves of claim 8, wherein the pole drive unit is coupled to a lower end of the antenna pole to increase or decrease a length of the antenna pole.

10. The device for receiving radio waves of claim 8, wherein the signal processing units each comprise a buffer and a filter, which are used to process radio waves received from the antenna module.

11. The device for receiving radio waves as set forth in claim 8, wherein the signal processing units are provided in a head unit.

12. The device for receiving radio waves of claim 11, wherein the head unit is connected with the antenna module using a cable.

13. The device for receiving radio waves of claim 12, wherein the cable is a single cable.

14. A motor vehicle comprising a device for receiving radio waves of claim 1.

15. A motor vehicle comprising a device for receiving radio waves of claim 8.
